(19) United States
(12) Patent Application Publication
(10) Pub. No.: US 2002/0158845 A1
(43) Pub. Date: Oct. 31, 2002

(54) Adjustable, divided, convex keyboard

(76) Inventor: Thomas W. Anderson, Apex, NC (US)

Correspondence Address: Thomas W. Anderson, 1209 Boxwood Ln., Apex, NC, 27502, US

(21) Appl. No.: 09/840,740

(22) Filed: Apr. 25, 2001

(51) Int. Cl. G09G 5/00

(52) U.S. Cl. 345/168

(57) ABSTRACT

A keyboard of the general type that is compatable with computers and related equipment. A keyboard consisting of two equal sized halves so mounted that either half cam be rotated independly about a common axis that is located at the top inside edge of both halves.

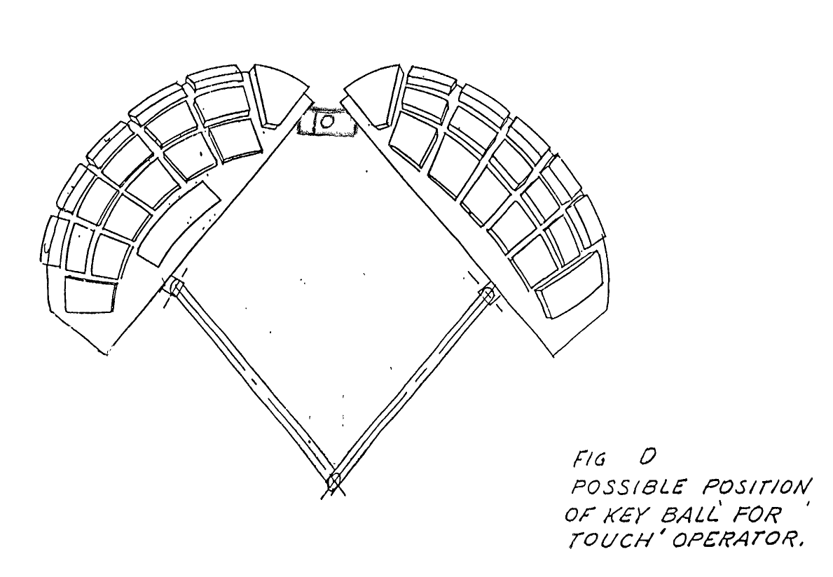

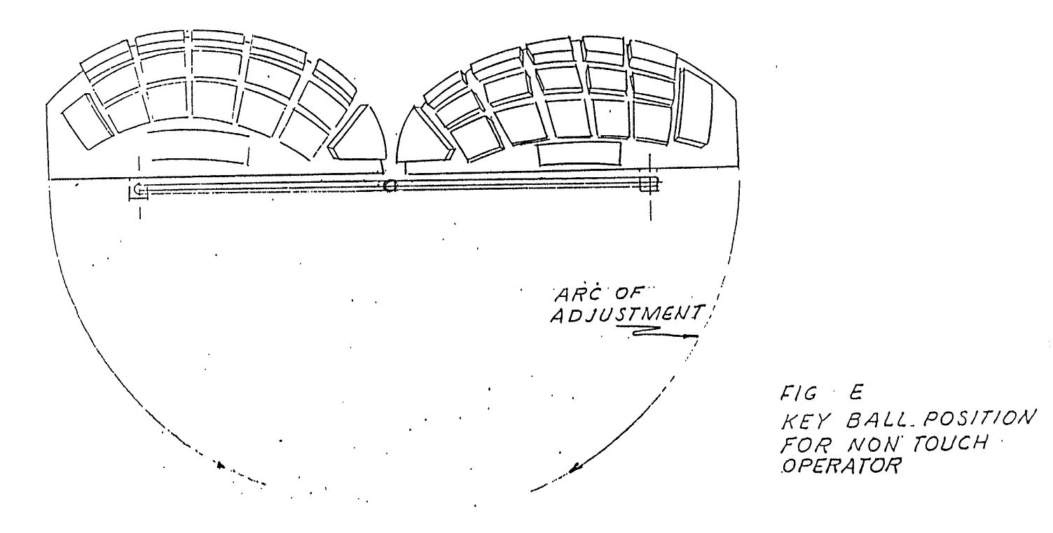

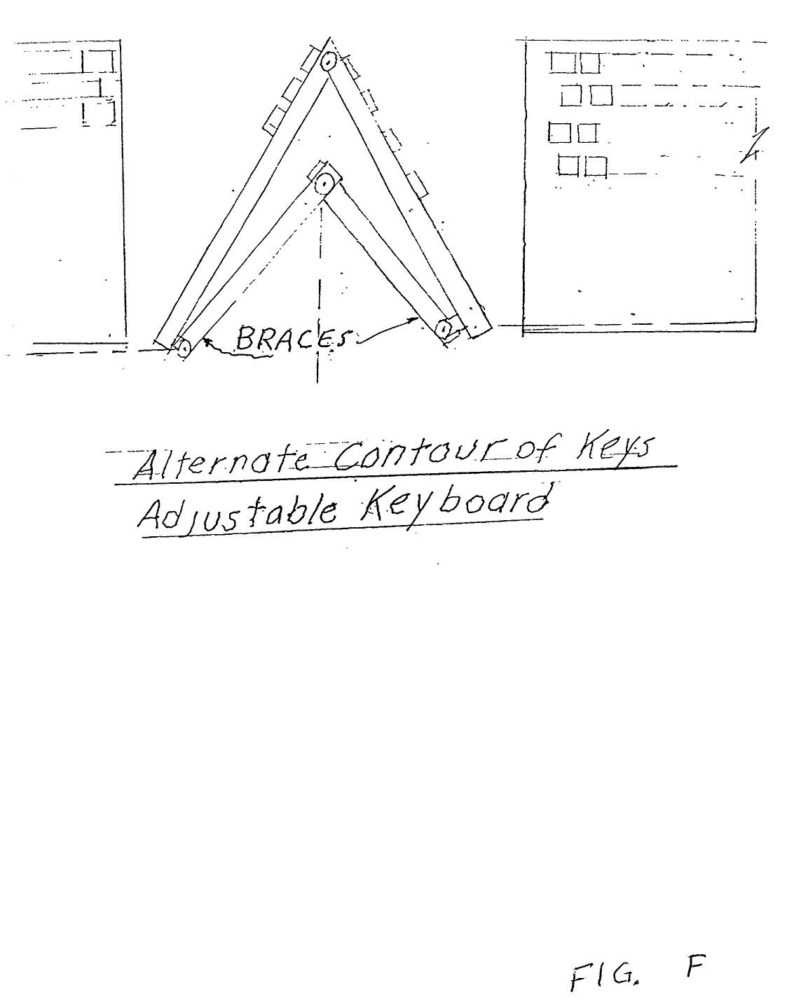

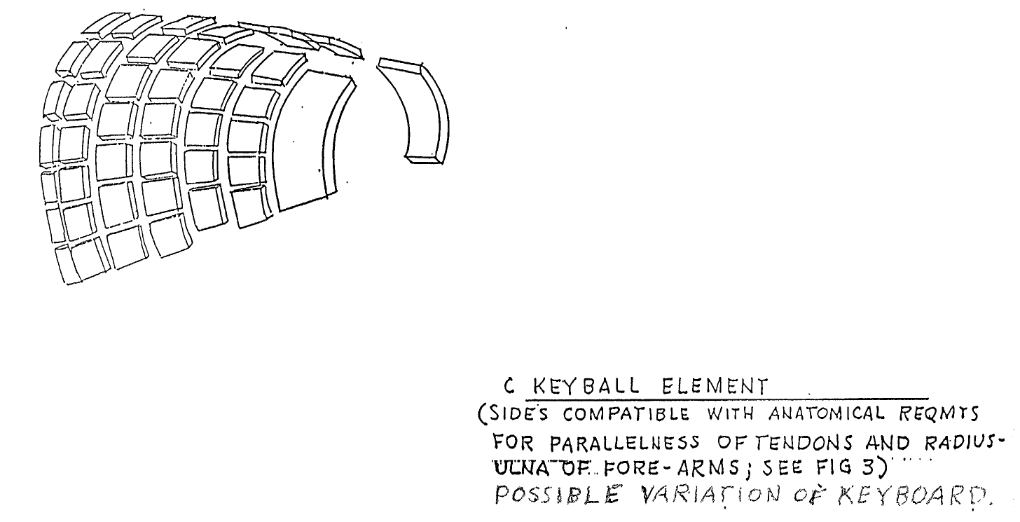

This division would occour between the digit key 6 and the digit key 7 of the top row and the B and N keys of the bottom row. This adjustment being controled by a pair of arms that connect the the extreme outside edges of each half and are friction controled.

### SUMMARY AND OBJECT OF THE INVENTION

The purpose of this invention is to relieve the physological strain of the persons operating computers by improving the individual's interaction with the computer work station. This will be accomplished by enabling the operator to vary body position and physical relation to the key board, the display tube, and most important, the position of the hands and fore arms with respect to the keyboard. By supporting the individual's arms, the back and shoulders will be relived of strain of maintaining necessary position to efficiently perform at a computer work station.

The bones in the forearms are somewhat crossed when the hands are in position to operate a conventional flat keyboard. Said bones are parallel when in position to operate the keyboard described in this disclosure (when the two halves are adjusted in a somewhat vertical and parallel position).

Furthermore the ability to change position, and/or to relocate the keyboard closer or further away from the operator without having to move one's chair adds another degree of convenience for the operator.

### GENERAL DESCRIPTION OF THE VIEWS

In view A the general layout of the main parts of the new work station are: View B shows new keyboard, locks 6, 7, 8. Also shown are the anchors to a desk with necessary friction locks at the elbow joints.

### DETAIL DESCRIPTION OF THE VIEWS

FIG. D shows the keyboard, which is the essence of this invention. View C shows the contour of the keys, being further explained in the abstract. The ideal curvature that would mostly fit the location of the tips of the finger tips of an average human hand when such hand is extended in a relaxed position.

View E shows the key board in the position where the dihedral angle between the two halves is approximately 180 degrees.

View F shoes an alternate contour of the key board surfaces which is plane.

View D shows one of many possible positions the two halves can be adjusted to. Aso shown are the adjustable arms for stabilizing the keyboard halves.

1. A keyboard for computer input wherein the theorical plane surface that the keys lie in is somewhat spherical.

2. Futhermore a keyboard that consists of two symetrical halves.

3. The two halves are adjustable about a common axis. The dihedral angle between the two halves ranging between 0 and 180 degrees.
